(19) United States
(12) Patent Application Publication
(10) Pub. No.: US 2006/0147111 A1
(43) Pub. Date: Jul. 6, 2006

(54) Method for creating a histogram

(76) Inventor: Andreas Loew, Gross-Gerau (DE)

Correspondence Address: THOMSON LICENSING INC., PATENT OPERATIONS, PO BOX 5312, PRINCETON, NJ, 08543-5312, US

(21) Appl. No.: 10/542,124

(22) PCT Filed: Dec. 24, 2003
(86) PCT No.: PCT/EP03/14898

§ 371 Date: Jul. 13, 2005

(30) Foreign Application Priority Data
Jan. 16, 2003 (DE) 103 01 407.1

(51) Int. Cl. G06K 9/00; G06F 17/18

(52) U.S. Cl. 382/168; 702/180

(57) ABSTRACT

The invention relates to a method for creating a histogram representing the distribution of supplied quantities which are associated with supplied values within a pre-determined value range, said value range being divided into pre-determined partial ranges which are defined by supporting values. For values which lie between a supporting value and an adjacent supporting value, division factors are calculated according to the position thereof. The quantities are divided according to the respective division factors between the respective supporting value and the adjacent supporting value, and are separately accumulated according to supporting values. The accumulated values are divided by the number of division factors which are respectively separately accumulated according to supporting values.

### TECHNICAL FIELD

The invention relates to a method for formation of a histogram that represents the distribution of supplied variables, which are associated with supplied values that are within a predetermined value range.

### BACKGROUND TO THE INVENTION

When analysing signals, it is frequently necessary to record variables, which are associated with individual values (sample values) of the signals, statistically separated according to their values. In this case, the variables to be recorded are frequently discrepancies from target values. In practice, the values are frequently within a wide value range of, for example, 1024 for ten-bit coding of an analog signal. In order to create a histogram, facilities for addition of the variables (accumulators) would then be required per se for each of these 1024 possible values. This involves considerable complexity.

### DESCRIPTION OF THE INVENTION

The method according to the invention allows the formation of such histograms with less effort, in that the value range is subdivided into predetermined sub-ranges, which are bounded by support values, in that sharing factors are calculated for values which are between one support value and an adjacent support value, as a function of their position, in that the variables are distributed between the respective support value and the adjacent support value as a function of the respective sharing factors, and are accumulated separately on the basis of the support values, and in that the accumulated values are divided by the total number of sharing factors which have in each case been accumulated separately on the basis of the support values.

The method according to the invention is particularly suitable for use with digital video signals, in which case the variables represent discrepancies from the ideal signal profile resulting, in particular, from non-linearities of transmission elements that operate on an analog basis, such as optoelectrical transducers. However, it is also possible to form different histograms using the method according to the invention, in particular for applications in which the variables do not fluctuate to a major extent from one value to the next.

A development allows subdivision between two adjacent accumulators in an advantageous manner in that a sharing factor is in each case derived from the difference between the supplied value and the support value, in that a further sharing factor is in each case formed by formation of the complementary value of the one sharing factor, in that the variables are each multiplied by the one sharing factor and by the other sharing factor, and in that both products, which are each associated with one variable, are accumulated in accumulators for adjacent value ranges.

The method according to the invention can be carried out in such a way that the sharing factors are derived linearly from the differences.

However, it is also possible to take account of different characteristics of the variables, in particular of the discrepancies, by deriving the subdivision factors from the differences, using a non-linear function.

### BRIEF DESCRIPTION OF THE DRAWING

One exemplary embodiment of the invention will be explained in more detail in the following description, and is illustrated in the form of a block diagram in the drawing.

### DESCRIPTION OF THE EXEMPLARY EMBODIMENT

The exemplary embodiment as well as parts of it are actually illustrated as block diagrams. However, this does not mean that the arrangement according to the invention is restricted to an implementation with the aid of individual circuits which correspond to the blocks. In fact, the arrangement according to the invention can be implemented in a particularly advantageous manner by means of large-scale integrated circuits. In this case, it is possible to use digital signal processors which, when programmed appropriately, carry out the processing steps illustrated in the block diagrams.

Inputs 1, 2 are supplied with the values VA (=value) and DE (=deviation) which are required to form the histogram, with DE being dependent on VA, and VA being able to assume a value range which results from the number of bits V. On the assumption that VA may assume 16 values, the number of bits is V=4. In addition, the example is based on the assumption that N+1=5 support values, specifically 0, 4, 8, 12, 16, are chosen for this value range, thus resulting in the overall value range being subdivided into N=4 sub-ranges, in each of which the variables DE are accumulated. In this case, the support value 16 assumes a special position, since the value 16 is never reached with a 4-bit number, although it is required later for accumulation of the shares of the values which are above the support values for 12.

A value range or the support value which is the lower limit of the value range in which the respective value VA is located is chosen in a selector 3. An address As for the respective value range is obtained by formation of the integer Int(VA*N/2ˆV), and is passed to changeover switches 4, 5. This ordinal number can assume the range 0 to N-1.

That support value which is subtracted from the value VA in element 7 is calculated from As by multiplication of the ordinal number by 2ˆV and division by N, thus resulting in a difference value D. This difference value can be influenced, for example made non-linear, in a look-up table 8.

In the range of the value VA from 0 to 15 and the support values at 0, 4, 8 and 12, quoted by way of example, the difference value may be 0, 1, 2 or 3. If non-linearisation is intended to be possible by means of the look-up table, finer quantization of the output values D′ from the look-up table 3 is required, for example from 0 to 15. The following values are then obtained for a linear table:

| | | | | |
|---|---|---|---|---|
| D | 0 | 1 | 2 | 3 |
| D′ | 0 | 4 | 8 | 12, |

while a non-linear table can be formed, for example, as follows:

| | | | | |
|---|---|---|---|---|
| D | 0 | 1 | 2 | 3 |
| D′ | 0 | 1 | 4 | 9 |

The difference D′, which therefore need not necessarily be the same as D, is used as sharing factor for distribution of the variables DE supplied at terminal 2 among two adjacent accumulators. For this purpose, the sharing factor D′ is passed directly to a first multiplier 10, and to a second multiplier 11 via a circuit 9 for formation of the complement K-D′ as a further sharing factor. In the numerical example that has been used K equals 16. The output variables Io and Iu from the multipliers 10, 11 are added, in each case, in one upper and one lower of two adjacent accumulators. The sharing factors D′ and K-D1 are supplied as counting variables Co and Cu to an upper and a lower of two adjacent further accumulators (counting accumulators).

The accumulators are arranged in two groups 12, 13. The group 12 comprises accumulators from Akku0 to AkkuN, to which the variables Iu and Io are passed via a changeover switch 4. The group 13 comprises counting accumulators (CAkku0 to CAkkuN), which are likewise driven via a changeover switch 5. The changeover switches 4, 5 are controlled by As.

If, by way of example, VA equals 7, the selector 3 emits As=1. The lower contacts of the changeover switches 4, 5 are thus moved to the position 1, and the upper contacts are moved to the position 2. When VA=7, then DA=3, which results in D′=12 for a linear look-up table 8. DE is thus multiplied by 12 in the multiplier 10, and by 16−12=4 in the multiplier 11. The Akku2 is accordingly supplied with twelve times DE, and Akku1 with four times DE. The corresponding counting accumulators contain the values 12 and 4.

When a sufficiently large number of variables DE have been accumulated for a sufficiently large number of values VA, the contents of the accumulators 12 are divided by the contents of the counting accumulators 13, in a computer 14. The results of this division then form a value of the histogram for each of the support values.

1. A method for formation of a histogram using accumulators which are associated with respective support points, wherein the range of the possible input values is subdivided into sub-ranges, which are bounded by two support values, wherein each support value has an associated accumulator, wherein a subtractor calculates the difference between the input value and a support value of the sub-range in which the input value is located, in that a first sharing factor is calculated from the difference, in that the complement value of the first sharing factor forms a second sharing factor, in that a multiplier multiplies the input value by the first and the second sharing factors, in that the products of the input values and of the sharing factors are accumulated by the accumulators which are associated with the support values, and in that a divider divides the accumulated values by the total number of sharing factors which have in each case been accumulated separately on the basis of the support values.

2. The method as claimed in claim 1, wherein the sharing factors are derived linearly from the differences.

3. The method as claimed in claim 1, wherein the sharing factors are derived from the differences by means of a non-linear function.

4. The method as claimed in claim 3, wherein the non-linear function is stored in a look-up-table.

5. A circuit for formation of a histogram with accumulators, which are associated with respective support points, wherein the range of the possible input values is subdivided into sub-ranges, which are bounded by two support values, wherein each support value has an associated accumulator, wherein an input value is supplied via an input to a selector by means of which a sub-range can be selected, which matches the input value, wherein an address signal is applied to selection switches for selection of the associated accumulator, in that a subtractor is provided by means of which the value of the lower support value in the sub-range can be subtracted from the input value, in that the difference is supplied as an input signal to a look-up-table, whose output signal is a first sharing factor, in that the first sharing factor is supplied to a first multiplier to which a discrepancy value is supplied as a further factor, and whose output signal is supplied to a first accumulator, which is selected by the address signal, in that the output value from the look-up-table is supplied as a first counting variable to a first counting accumulator which is selected by means of the address signal, in that a complement circuit forms the complement of the output signal from the look-up-table, wherein the complement is supplied as a second counting variable to a second counting accumulator which is selected by means of the address signal, in that the complement is supplied to a second multiplier, to which the discrepancy value is supplied as a further factor, and whose output signal is supplied to a second accumulator, which is selected by the address signal, and in that a divider circuit divides the contents of the first and second accumulators by the contents of the respectively associated counting accumulators.
